(19) United States
(12) Patent Application Publication
(10) Pub. No.: US 2018/0195771 A1
(43) Pub. Date: Jul. 12, 2018

(54) Arrays with Panels Having Magnetically-Controlled Connectors for Attachment to a Support Member

(71) Applicant: David Lynn, Welcome, NC (US)

(72) Inventor: David Lynn, Welcome, NC (US)

(21) Appl. No.: 15/665,767

(22) Filed: Aug. 1, 2017

Related U.S. Application Data
(63) Continuation-in-part of application No. 15/401,868, filed on Jan. 9, 2017.

(51) Int. Cl. F24J 2/52; H02S 20/26; H02S 20/30

(52) U.S. Cl. CPC F24J 2/5256; F24J 2/526; H02S 20/30; H02S 20/26; F24J 2/5262

(57) ABSTRACT

The present application is directed to an array that includes one or more panels that are engaged with one or more support members. The panels include one or more magnetically-controlled connectors for attaching to one of the support members. The connector is attached to the panel and is configurable between locked and unlocked positions. In the locked position, an arm extends outward to engage with the exterior support member. In the unlocked position, the arm is retracted inward and is disengaged from the support member. The connector is configured to be movable between the positions using a magnetic actuator that is selectively moved into and out of proximity of the connector.

### RELATED APPLICATIONS

The present application is a continuation-in-part of application Ser. No. 15/401,868 which was filed on Jan. 9, 2017 and is herein incorporated by reference in its entirety.

### BACKGROUND

The present application is directed to arrays that include panels with connectors that engage with support members and, more particularly, to arrays with panels having connectors that are movable between engaged and disengaged positions to secure the panel to the support members.

Connectors are used in a variety of different applications to connect a first member to a second member. The connectors may be attached to a first member in a variety of different manners. The connectors may be adjustable between a locked position in which the first member is secured to the second member, and an unlocked position in which the first member is not secured to the second member.

The connectors may be positioned on the first member in a manner such that they are not easily accessible. This may occur when the connector is positioned along a back side of the panel in a position that is difficult to access when positioned at the second member. This may make securing the connectors to the second member difficult due to the lack of access. For instance, a connector on the back side of a solar panel may not be accessible to an installer once the solar panel is positioned on the top of a frame. Likewise, a connector on a back of a plywood panel may not be accessible once the panel is placed against wall studs.

### SUMMARY

The present application is directed to an array that includes one or more panels connected to one or more support members. The panels is configured with one or more connectors that provide for a secure attachment. The connectors are configured to be positioned between an engaged position to secure the panel to the support, and a disengaged position to release the panel from the support.

One embodiment is directed to an array that includes supports with a top surface and side walls that extend outward away from the top surface, and an opening formed between the supports. At least one of the side walls at the opening includes a contact member. A panel is sized to be positioned over the top surface of the supports and extend across the opening. The panel includes a first side that is exposed when the panel is positioned at the opening and an opposing second side that faces towards the top surface when the panel is positioned at the opening. The panel also includes an outer edge that extends between the first and second sides. A connector is attached to the second side of the panel. The connector includes an engagement member configured to move relative to the panel between an engaged position that extends outward away from a center of the panel and a retracted position that is retracted inward towards the center of the panel, and a ferromagnetic member configured to be acted upon by a magnetic force and move relative to the panel between a first position and a second position. The ferromagnetic member is selectively positioned between the first position that locates the engagement member in the engaged position in contact with the contact member on the side wall, and the second position that locates the engagement member in the retracted position inward towards the center of the panel and out of contact with the contact member on the side wall.

The supports may extend completely around the opening.

The connector may also include a spring that biases the engagement member towards the engaged position.

The contact member may be positioned at an incline with a distal end of the contact member contacting against the incline in the engaged position to apply a force to the panel that pulls the panel towards the top surface of the supports.

A seal may be positioned between the top surface of the supports and the second side of the panel with the seal constructed from a material that is more compressible than the supports with the seal being compressed when the connector is in the engaged position and in contact with the contact member in the side wall.

At least one of the side walls at the opening may include an inwardly-angled face with a width of the opening being larger at the top surface of the supports and smaller at a bottom of the supports, and with the connector having an outer face with a complementary angle such that the outer face of the connector contacts against the at least one of the side walls when the panel is positioned at the opening.

The side walls of the supports may include a notch and the connector may include a lip that extends outward away from the second side of the panel, wherein the lip is sized to seat within the notch when the panel is positioned at the opening.

At least one of the side walls may include a gap and the engagement member may extend into the gap in the engaged position.

A side seal may be mounted on the connector and configured to contact against the side wall when the engagement member is in the engaged position to prevent water from contacting against the engagement member.

Another embodiment is directed to an array that includes a panel with first and second planar sides. First and second connectors are attached to the second side of the panel at opposing edges of the panel. Each of the connectors includes: a contact face that extends at an acute angle from the second side of the panel; a lip; and an engagement member movable between an extended position that extends outward from the contact face and a retracted position that is retracted inward from the contact face. A frame includes a first support and a second support with the frame having an opening formed between the first support on a first side of the opening and the second support on a second side of the opening. Each of the first and second supports includes a top surface, a side wall that extends outward away from the top surface and includes an inwardly-angled face that complements the acute angle of the contact face, a contact member positioned in the side wall, and a receptacle positioned below the side wall. The panel is positioned on the frame and extends over the top surface of each of the first and second supports and with each of the connectors positioned with the outer face of each of the connectors in contact against the face of one of the side walls and with the engagement member of each of the connectors in the extended position being in contact with the contact member of one of the supports, and with the lip of each of the connectors positioned in the receptacle of one of the supports to prevent the connector from moving away from the side wall towards a center of the opening.

The opening may include a width measured between the first and second supports with the width of the opening being greater at the top surface of the supports and smaller at a bottom of the supports.

Each of the connectors may include a body with the contact face positioned on a lateral side of the body with the lip positioned on a bottom side of the body, and a top side of the body being attached to the second side of the panel.

Each of the connectors may include a ferromagnetic member movable in a plane that is perpendicular to the first side of the panel with the ferromagnetic member being selectively positioned between a first position that is a first distance away from the first side of the panel that positions the engagement member in the extended position against the contact member, and a second position a different second distance away from the first side of the panel that positions the engagement member in the retracted position inward towards the center of the panel and out of contact with the contact member.

The panel may be a solar panel and the first side of the panel is exposed when the panel is positioned on the frame.

The engagement member of each of the connectors may extend outward beyond the edges of the panel in the extended position.

The connectors may be configured to apply a force to the panel that pulls the panel towards the top surface of the supports when the connectors are in the engaged position and in contact with the contact members in the side walls.

A seal may be positioned between the top surface of the supports and the second side of the panel with the seal constructed from a material that is more compressible than the supports with the seal being compressed when the connectors are in the engaged position and in contact with the contact members in the side walls.

Each of the connectors may include a ferromagnetic member movable in the housing between a first position that positions the engagement member in the extended position against the contact member, and a second position away from the first position that positions the engagement member in the retracted position inward towards the center of the panel and out of contact with the contact member.

Another embodiment is directed to an array that includes a panel with first and second planar sides and having a polygonal shape with at least first and second outer edge sections on opposing sides of the panel. First and second connectors are attached to the second side of the panel with the first connector attached at the first outer edge section and the second connector attached at the second outer edge section. Each of the connectors includes: a body that extends outward away from the second side of the panel with a contact face oriented at an acute angle from the second side of the panel, the body also comprising a bottom side with a lip; and an engagement member movable between an extended position that extends outward from the contact face and a retracted position that is retracted inward from the contact face. A frame includes an opening sized to receive the panel with the frame having a first support on a first side of the opening and a second support on a second side of the opening and the opening having a width measured between the first and second sides that is greater at a top and smaller at a bottom and each of the first and second supports further comprising notches. The panel is configured to be positioned on the frame to extend over the first and second supports and with the contact face of the first connector abutting against the first support and the contact face of the second connector abutting against the second support. The lip of first connector is configured to be inserted into the notch of the first support and the lip of the second connector is configured to be inserted into the notch of the second support to prevent the panel from moving away from the first and second supports towards a center of the opening.

One embodiment is directed to a panel configured to be attached to a support. The panel includes a planar body with a first side and an opposing second side, and an outer edge. At least two connectors are attached to the second side of the body. Each of the connectors include: an engagement member movable between a first position that extends outward away from a center of the body and a second position that is retracted inward towards the center of the body; a spring that biases the engagement member towards the first position; and a ferromagnetic member movable towards and away from the first side of the body. Each of the connectors is selectively positioned between an engaged configuration with the ferromagnetic member a first distance away from the first side of the body to locate the engagement member in the first position and a disengaged configuration with the ferromagnetic material a different second distance away from the first side of the body to locate the engagement member in the second position.

The engagement member of each of the connectors may extend outward beyond the outer edge of the body in the first position. This may include that the engagement member of each of the connectors is retracted inward within the outer edge of the body in the second position.

The body may include a polygonal shape with multiple straight sides and the connectors are positioned along at least two of the sides.

The connectors may be positioned on opposing sides of the body.

The first side of the body may be flat.

The connectors may include a sliding contact member positioned between the engagement member and the spring.

The ferromagnetic member may include a wedge shape with a first longitudinal width at a top of the member closer to the planar body that is different than a second longitudinal width at a bottom of the member.

Another embodiment is directed to a panel configured to be attached to a support. The panel includes a planar body with a first side that is exposed when the panel is attached to the support, an opposing second side that faces the support when the panel is attached to the support, and an outer perimeter with at least first and second edges. At least two connectors are attached to the second side of the body with at least one of the connectors positioned along each of the first and second edges. Each of the connectors includes: an engagement member movable between a first position that extends outward away from a center of the body and a second position that is retracted inward towards the center of the body; a spring that biases the engagement member towards the first position; and a ferromagnetic member movable towards and away from the first side of the body. The ferromagnetic member is selectively positioned between an engaged configuration with the ferromagnetic member a first distance away from the first side to locate the engagement member in the first position and a disengaged configuration with the ferromagnetic material a different second distance away from the first side to locate the engagement member in the second position.

The panel may be constructed from cardboard.

Another embodiment is directed to a method of securing a panel to a support with a planar first side of the panel being exposed. The panel includes connectors attached to the planar second side. The method includes: biasing an engagement member in each of the connectors away from a center of the panel to an engaged position; magnetically attracting a positioning member in each of the connectors towards the first side of the panel and overcoming the biasing force thereby retracting the engagement member inward towards the center of the panel to a retracted position; and moving the positioning member in each of the connectors away from the first side of the panel and returning each of the engagement members to the engaged position.

The method may also include removing the magnetic attraction on each of the positioning members and causing the positioning member in each of the connectors to move away from the first side of the panel.

The method may include applying the biasing force to the engagement members in each of the connectors and returning each of the engagement members to the engaged position.

The method may include biasing the engagement member in each of the connectors away from the center of the panel and outward beyond a perimeter edge of the panel.

The method may include retracting the engagement member in each of the connectors inward to the retracted position that is inward from the perimeter edge of the panel.

The method may include applying the biasing force outward from a center of the panel.

The method may include moving the engagement member in each of the connectors between the engaged and retracted positions in a plane that is parallel to the first side of the panel.

The method may include locking the engagement member in each of the connectors in the retracted position by engaging an arm of the connector in a receptacle in a body of the connector.

The method may include magnetically attracting an arm in each of the connectors that is secured to a body of the connector towards the first side of the panel and unlocking the engagement member and moving the engagement member to the engaged position.

The various aspects of the various embodiments may be used alone or in any combination, as is desired.

### BRIEF DESCRIPTION OF THE DRAWINGS

FIG. 1A is a schematic side view of a connector in a locked position.

FIG. 1B is a schematic side view of a connector in an unlocked position.

FIG. 2A is a lower perspective view of a connector in a locked position.

FIG. 2B is a lower perspective view of a connector in an unlocked position.

FIG. 3 is a lower perspective view of a support member.

FIG. 4 is a schematic side view of a connector in a locked position.

FIG. 5 is a schematic side view of a connector in a locked position.

FIG. 6A is a perspective bottom view of a connector in a locked position.

FIG. 6B is a perspective bottom view of a connector in an unlocked position.

FIG. 7A is a schematic side view of a connector in a locked position.

FIG. 7B is a schematic side view of a connector in an unlocked position.

FIG. 8A is a schematic side view of a connector with a latch in alocked position.

FIG. 8B is a schematic side view of a connector with a latch in an unlocked position.

FIG. 9 is a bottom view of a solar panel with two connectors.

FIG. 10 is a bottom view of a solar panel with four connectors.

FIG. 11 is a perspective view of a solar array with one panel being exploded outward from the array.

FIG. 12 is a schematic side view of a solar panel with opposing connectors that each engage with corresponding support members.

FIG. 13 is a schematic side view of a solar panel with opposing connectors that each engage with corresponding support members.

FIG. 14 is a perspective view of a connector in an extended position,

FIG. 15 is a sectional view of the connector of FIG. 14 cut along line XV-XV.

FIG. 16 is a sectional view of the connector of FIG. 15 in a retracted position.

FIG. 17 is a schematic sectional view of a connector in an extended position and attached to a panel and a magnetic tool on an opposing side of the panel.

FIG. 18 is a perspective view of a solar array with one panel being exploded outward from the array.

FIG. 19 is a schematic sectional view of a pair of panels electrically connected to a support member cut along line XIX-XIX of FIG. 18.

FIG. 20A is a partial sectional view of a connector in a disengaged position positioned at a support member.

FIG. 20B is a partial sectional view of a connector in an engaged position positioned at a support member.

### DETAILED DESCRIPTION

The present application is directed to an array that includes one or more panels that are engaged with one or more support members. The panels include one or more magnetically-controlled connectors for attaching to one of the support members. The connector is attached to the panel and is configurable between locked and unlocked positions. In the locked position, an arm extends outward to engage with the exterior support member. In the unlocked position, the arm is retracted inward and is disengaged from the support member. The connector is configured to be movable between the positions using a magnetic actuator that is selectively moved into and out of proximity of the connector.

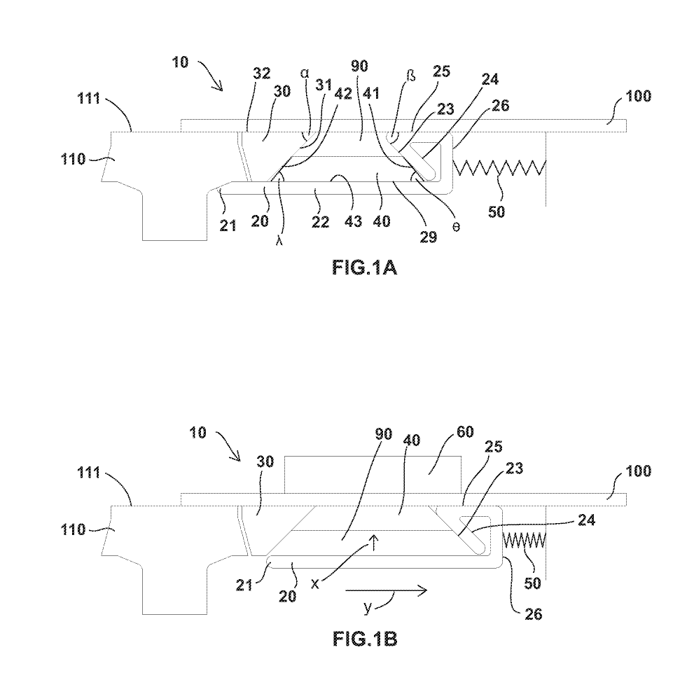

FIGS. 1A and 1B illustrate a connector 10 that is attached to a panel 100. The connector 10 is connected to an underside of the panel 100 and configured to engage with an exterior support member 110. The connector 10 includes a movable support 20 that is movably attached to the panel 100, a fixed support 30 that is fixedly attached to the panel 100, an engagement member 40 positioned between the supports 20, 30, and a biasing member 50.

A holding space 90 is formed between the supports 20, 30. The holding space 90 is sized to hold the engagement member 40. In use, the connector 10 is forced towards the locked position by the biasing member 50 as illustrated in FIG. 1A. This includes a distal end 21 of the movable support 20 extending outward to engage with the support member 110. The engagement member 40 is positioned in a lower section of the holding space 90 away from the panel 100 to contact against lower sections of the supports 20, 30 and space them apart by a first distance.

To move the connector 10 to the locked position as illustrated in FIG. 1B, a magnetic actuator 60 is brought into proximity to the engagement member 40. This may include positioning the actuator 60 against the top surface of the panel 100 as illustrated in FIG. 1B. The actuator 60 magnetically attracts the engagement member 40 in the direction of arrow X towards an upper section of the holding space 90. This movement may be perpendicular to the first and/or second sides of the panel 100. This upward movement causes the engagement member 40 to slide against the supports 20, 30. The shapes of the engagement member 40 and supports 20, 30 cause the movable support 20 to move away from the fixed support 30 in the direction of arrow Y. This movement causes the distal end 21 to move away from and disengage from the fixed support 110.

To return the connector 10 to the locked position, the actuator 60 is removed from proximity of the engagement member 40. This removes the magnetic force thus causing the engagement member 40 to move downward towards the lower section of the holding space 90.

In use, each of the connectors 10 is selectively positioned between an engaged configuration with the engagement member 40 a first distance away from the first side of the panel 100. This results in the arm 22 of the connector 10 extending outward and engaging with a support member 110. In one embodiment, this includes the distal end 21 of the arm 22 being positioned outward beyond an outer edge of the panel 100. The connectors 10 may also be positioned in a disengaged configuration with the engagement member 40 a different second distance away from the first side of the panel 100. This results in the arm 22 retracted inward and disengage from the support member 110. This may include the distal end 21 being positioned within the outer edge of the panel 100.

A first element of the connector 10 is the support 20. The support 20 includes a contact section 24 and an elongated arm 22. The contact section 24 includes a top surface 25 that contacts against and moves along the underside of the panel 100. A contact surface 23 is positioned proximate to the top surface 25 and is positioned to contact against the engagement member 40. The contact surface 23 is oriented at an angle ß relative to the top surface 25. One aspect includes the angle ß being an acute angle. The contact section 24 also includes a surface 26 against which the biasing member 50 applies the biasing force.

The connector 10 also includes an elongated arm 22 that extends outward from the contact section 24 and terminates at the distal end 21. The arm 22 may form a lower boundary of the holding space 90. The arm 22 may extend under the engagement member 40 and support the engagement member 40 in the unlocked position.

The support 30 is fixedly attached to the panel 100 and contacts against the engagement member 40. The support 30 includes a top surface 32 that is attached to the panel 100 and a contact surface 31 that is contacted by the engagement member 40. The contact surface 31 may be positioned at an angle α relative to the top surface 32. The angle α is an acute angle and may or may not be the same as angle ß. The support 30 may also be contacted by the arm 22 of the support 20 in one or both of the locked and unlocked positions.

The holding space 90 is formed between the supports 20, 30. The holding space 90 includes a width measured between the contact surfaces 23, 31. The width varies along the holding space 90 due to the angular orientation of the surfaces 23, 31. The width is smaller at the upper section of the holding space 90 in proximity to the panel 100 and larger at the lower section. The size of the holding space 90 varies due to the movement of the support 20.

The engagement member 40 is positioned within the holding space 90 and contacts against each of the supports 20, 30. The engagement member is constructed from a ferromagnetic material that is magnetically attracted to the magnetic actuator 60. This may include the engagement member 40 being constructed from various materials, including but not limited to iron, cobalt, and nickel, and mixtures thereof. The engagement member 40 includes an elongated shape with bottom surface 43 that faces away from the panel 100 and opposing ends 41, 42. The first end 41 contacts against the support 20 and the second end 42 contacts against the support 30. The ends 41, 42 include ramped surfaces that may or may not match those of the respective contact surfaces 23, 31. The first end 41 is positioned at an acute angle θ relative to the bottom surface 43, and the second end 42 is positioned at an acute angle λ relative to the bottom surface 43. The ramped end 41 is configured to engage with and slide along the contact surface 23 of the member 20 and ramped end 42 is configured to engage with and slide along the contact surface 31. The ends 41, 42 may be ramped at the same or different angles. Aspects may include the first end 41 having the same angle as the contact surface 23 (i.e., θ=ß) and/or the second end 42 having the same angle as contact surface 31 (i.e., λ=α). In one aspect, the respective angles are the same.

The biasing member 50 applies a force to the movable support 20 to force the connector 10 towards the locked position. The biasing member 50 may include a variety of different structures, such as but not limited to a spring, cantilevered arm that extends from the arm 20, and foam material. The biasing member 50 may include a single element (e.g., a single spring) or multiple elements (e.g., multiple springs).

The actuator 60 magnetically attracts the engagement member 40 to move the engagement member 40 from a first position at the lower section of the holding space 90 to a second position that along the upper section of the holding space 90. The actuator 60 may comprise a variety of different magnets.

In use, the connector 10 is biased towards the locked position. This includes the biasing member 50 applying a force to the movable support 20 that forces it towards the support member 110. Without the actuator 60 in proximity as illustrated in FIG. 1A, the ramped engagement member ends 41,42 and corresponding contacts surfaces 23, 31 cause the engagement member 40 to be positioned in the lower section of the holding space 90. This may include the engagement member 40 being positioned against the arm 22 of the support 20. The length of the engagement member 40 measured between the ends 41, 42 positions the movable support 20 a distance from the fixed support 30 such that the distal end 21 of the arm 22 extends outward to engage with the support member 110. In this locked position, the end 41 of the engagement member 40 remains in contact with the contact surface 23 and end 42 remains in contact with the contact surface 31.

To move the connector 100 to the unlocked position, the actuator 60 is brought into proximity of the engagement member 40 as illustrated in FIG. 1B. This positioning causes the engagement member 40 to be magnetically attracted to the actuator 60. The force of the engagement member 40 being magnetically attracted towards the actuator 60 overcomes the force applied by the biasing member 50. The magnetic force causes the ramped ends 41, 42 to slide along the corresponding surfaces 23, 31 to an upper section of the holding space 90. This movement of the engagement member 40 causes the movable support 20 to move away from the fixed support 30. This movement results in the distal end 21 of the arm 20 retracting inward against the biasing force of the biasing member 50 and disengaging from the support member 110. In the unlocked position, the end 41 remains in contact with the contact surface 23 and end 42 remains in contact with the contact surface 31.

While in the unlocked position, the panel 100 can be positioned relative to the support member 110. Once positioned at the appropriate location, the actuator 60 is removed causing the connector 10 to return to the locked position and engage with the support member 110.

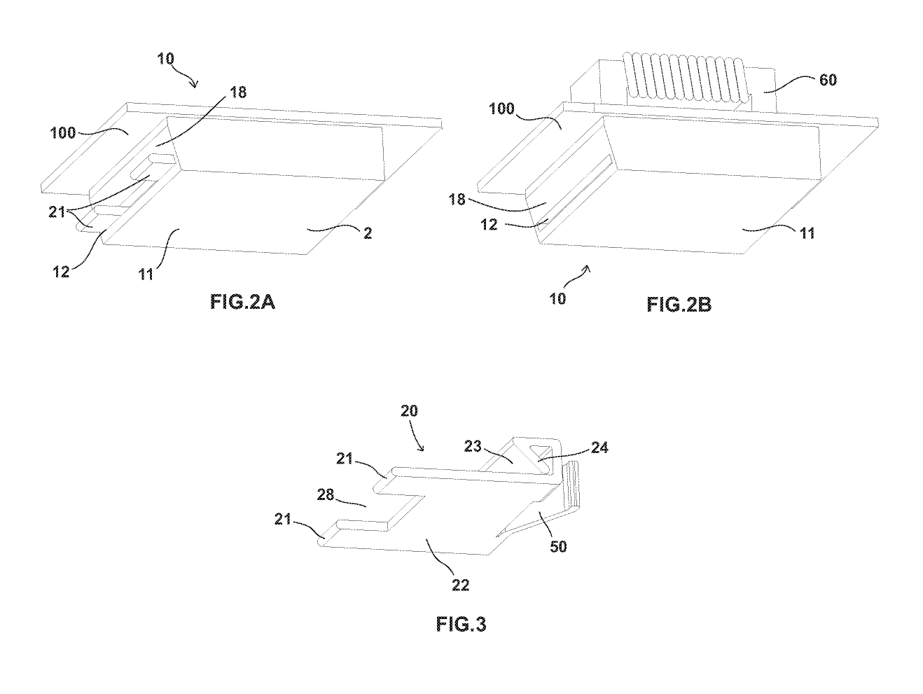

FIG. 2A illustrates a connector 10 attached to a panel 100 and in a locked position. FIG. 2B illustrates the connector 10 in an unlocked position due to the proximity of the actuator 60. The connector 10 includes an outer housing 11 that extends around the components. The housing 11 includes exterior walls 18 that extend around the components, and an opening 12 through which the distal end 21 of the arm 20 extends in the locked position (see FIG. 2A). A seal may be positioned at the opening 12 in the housing 11. This seal contacts against side of the support member 110 to again prevent the ingress of water and/or debris.

FIG. 3 illustrates a movable support 20 that is constructed from a sheet, such as a thin metal. One end of the sheet is folded to form the contact section 24 that includes the contact surface 23 that contacts against the engagement member 40. The sheet is further cut to form a cantilevered extension that extends outward from the contact section 24 to form the biasing member 50. The elongated arm 22 extends from the contact section 24 and terminates at the distal end 21. The arm 22 includes a pair of projections that are separate by a notch 28. The notch 28 is sized to extend around the support 30 that is fixedly positioned in the housing 11.

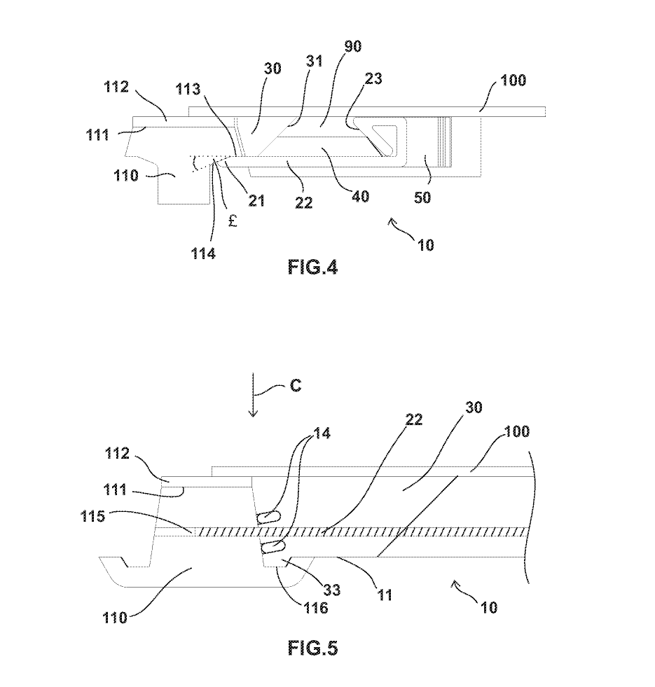

FIG. 4 illustrates the connector 10 in a locked position with the distal ends 21 of the arm 22 engaged with the support member 110. The engagement member 40 is positioned in a lower portion of the holding space 90 and in contact with each of the contact edges 31, 23. The biasing member 50 applies a force that moves the engagement member 40 downward against the arm 22 of the movable support 20.

The support member 110 is configured to engage with the connector 10 and support the panel 100. As illustrated in FIG. 4, the support member 110 includes a top surface 111 configured to support the edge of the panel 100. Each of the top surface 111 and underside of the panel 100 may be flat to facilitate the contact. A seal 112 may be positioned at the top surface 111 to contact against the underside of the panel 100. The seal 112 may be constructed from a flexible material that forms a water-tight seal to prevent the ingress of water and/or debris. The seal 112 may be constructed from a material that is more compressible than the support member 110.

The support member 110 may also be configured to facilitate the engagement with the connector 10 in the locked position. As illustrated in FIG. 4, the member 110 includes a first surface 113 that contacts against the distal end 21 and adjacent top surface of the arm 22. This contact locks the connector 10 and attached panel 100 to the support member 110. This first surface 113 may be relatively flat to facilitate contact and engagement with the flat top of the arm 22. A second surface 114 is positioned inward from the first surface 113. The second surface 114 is positioned at an acute angle £ relative to an inward projection of the first surface 113. This angle £ causes the arm 22 to apply a downward force that secures the contact between the underside of the panel 100 and the seal 112.

In one aspect when the connector 10 is engaged with the member 110, the engagement member 40 is not fully seated. That is, there is additional room for the engagement member 40 to move within the holding space. This causes a continuous bias on the support 20 thus creating a force applied to the member 110 by the arm 22. This force causes the panel 100 to be pulled onto the support 110. This force compresses the seal 112 to maintain a watertight connection to prevent the ingress of water and/or debris over time that could occur due to weather including wind and temperature changes.

FIG. 5 includes the support member 110 having a notch 116 formed to receive a lip 33 on the underside of the housing 11. When the connector 10 and panel 100 are positioned against the support member 110 in the direction indicated by arrow C, the lip 33 is received in the notch 116. Once received, the connector 10 can be moved to the locked position with the distal end 21 of the arm 22 inserted into a slot 115 in the support member 110.

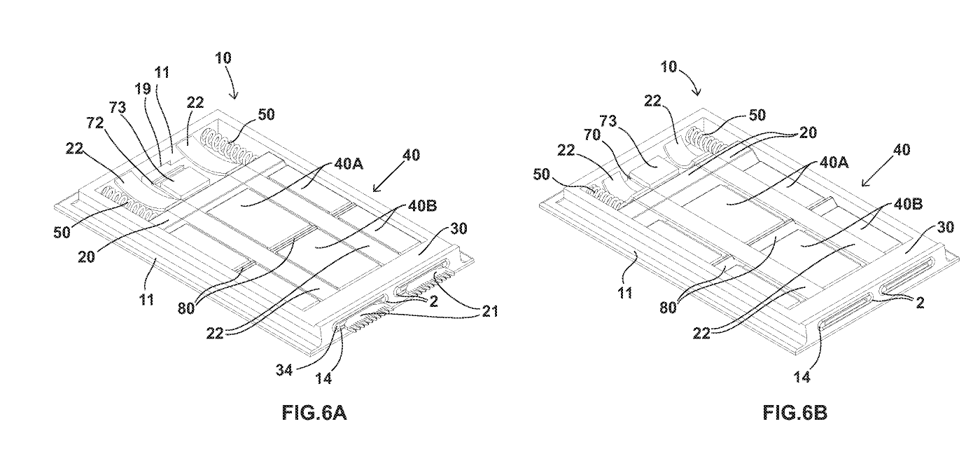

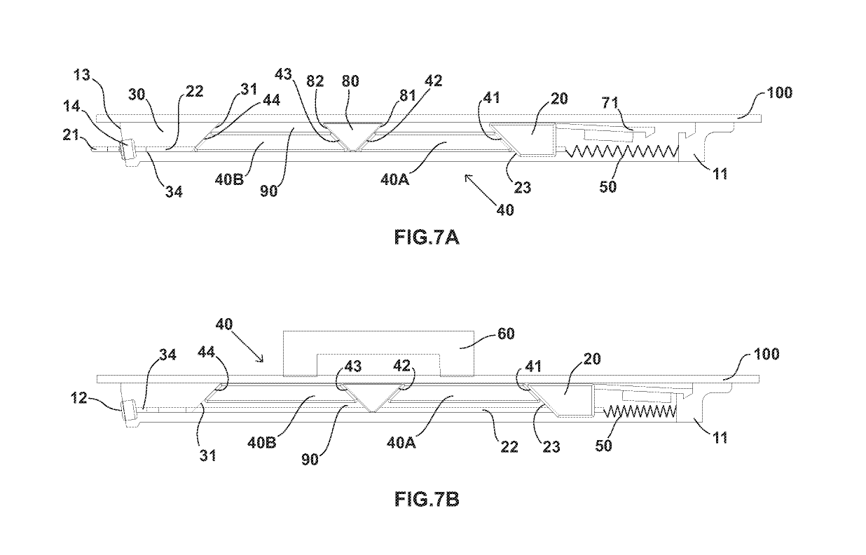

FIGS. 6A, 6B, 7A, and 7B illustrate another aspect of the connector 10. As illustrated, the connector 10 uses a multiple member engagement member 40 configuration to move between engaged and disengaged positions. In one aspect, the connector 10 is attached to a solar panel 100 (not illustrated in FIGS. 6A, 6B, 7A, 7B) and used to electrically connect to an adjacent solar panel 100. The connector 10 includes a housing 11 that extends around and protects the other components. The bottom of the housing 11 is removed in FIGS. 6A and 6B for clarity.

The connector 10 includes a pair of arms 22 that are movable between an extended orientation in the locked position as illustrated in FIGS. 6A and 7A, and a retracted orientation in the unlocked position of FIGS. 6B and 7B. The arms 22 are constructed from an electrically conductive material and engage with adjacent solar panels 100 in the locked position. Electrical connectors may be connected to the inner ends of the arms 22 to provide for electrical connections with the solar cells of the solar panel. The arms 22 may be electrically isolated within the connector 10. This may include an insulating material positioned underneath the arms 22 to provide electrical isolation. The arms 22 may also include extendable portions positioned between the support 20 and a back of the housing 11 (see FIGS. 6A, 6B). The extendable portions provide for maintaining electrical connection when the remainder of the arms 22 move between the locked and unlocked positions. Aspects may include a hinged configuration with an extendable length, a bowed configuration that is extendable and retractable, and a folded/pleated configuration.

The arms 22 are attached to the movable contact member 20. Thus movement of the contact member 20 results in movement of the arms 22. The contact member 20 includes a ramped contact surface 23 (see FIGS. 7A, 7B). A pair of biasing members 50 contact against the contact member 20 to apply a biasing force.

The fixed support 30 is positioned in the housing 11 and spaced away from the movable contact member 20. The fixed support 30 includes a ramped contact surface 31 that faces towards the contact member 20. In one aspect, the fixed support 30 is formed by the housing 11. Slots 34 extend through the fixed support 30 to receive the arms 22. The slots 34 are sized to allow the arms 22 to move back and forth between the locked and unlocked positions.

This aspect of the connector 40 includes a multiple-section engagement member 40 that is positioned in the holding space 90 between the members 20, 30. The engagement member 40 includes first and second engagement member sections 40A, 40B and an intermediate member 80. The engagement member sections 40A, 40B are constructed from a ferromagnetic material and are magnetically attracted to the magnetic actuator 60. The first engagement member section 40A is positioned in proximity to the movable support 20, and the second engagement member section 40B is positioned in proximity to the fixed support 30. Each engagement member section 40A, 40B includes front and back ends that are ramped. Engagement member section 40A includes ends 41, 42 and engagement member section 40B includes ends 43, 44 (FIGS. 7A, 7B). The angles of the ends of each engagement member section 40A, 40B may be the same or different. Likewise, the engagement member sections 40A, 40B may include the same or different shapes and/or sizes.

The intermediate contact member 80 is positioned between the first and second engagement member sections 40A, 40B. The intermediate contact member 80 moves relative to the housing 11 as the engagement member sections 40A, 40B move between the locked and unlocked positions. The intermediate contact member 80 includes a pair of ramped surfaces 81, 82. The first ramped surface 81 contacts against the end 42 of the first engagement member section 40A and the second ramped end 82 contacts against the end 43 of the second engagement member section 40B.

FIGS. 6A and 7A illustrate the connector 10 in the locked position. The connector 10 is attached to an underside of a panel 100 with the arms 22 electrically connected to the panel. One aspect includes the connector 10 used with a solar panel 100, with other aspects including other types of panels 100 that require electrical and/or physical connection to a support member 110. Another aspect is the panel including internal electrical wiring that is connected to the arms 22.

In the locked position, the distal ends 21 of the arms 22 extend outward from the housing 11. This provides for the distal ends 21 to engage with the support member 110 and/or electrical connectors that are associated with the support member 110. Seals 14 are attached to the housing 11 where the arms 22 extend outward. When the connector 10 is abutted against the support member, the seals 14 prevent the ingress of water and/or debris.

In the locked position, the biasing members 50 apply a force that is distributed to the movable support 20 and engagement member 40. This force and the angle of the ramped ends of the various surfaces that in contact forces the engagement member sections 40A, 40B towards a lower section of the holding space 90. That is, the angle of surface 23 against edge 41, surface 42 against edge 81, surface 82 against edge 43, and edge 31 against edge 44 forces the engagement members 40A, 40B downward. The arms 22 that are attached to the movable support 20 extend outward from the housing 11.

FIGS. 6B and 7B illustrate the connector 10 in the unlocked position. FIG. 7B includes an actuator 60 that creates a magnetic force on the engagement members 40. The actuator 60 is not illustrated in FIG. 6B for clarity.

When the magnetic actuator 60 is moved into proximity of the connector 10, a magnetic force acting on the engagement member sections 40A, 40B draws the engagement member sections 40A, 40B towards the actuator 60. This force causes the engagement member sections 40A, 40B to move upward in the holding space 90 and the ramped ends of the engagement members (ends 41, 42 of the engagement member section 40A, ends 43, 44 of the engagement member section 40B) to slide along the corresponding surfaces. The engagement member sections 40A, 40B include a fixed length and thus the upward movement causes the movable contact member 20 to move laterally away from the support 30 (i.e., move to the right as illustrated in FIG. 7B). As the arms 22 are attached to the movable contact member 20, this results in the arms 22 also moving laterally. This results in the distal ends 21 of the arms 22 being moved into the openings 12 and disengaging from the adjacent support member.

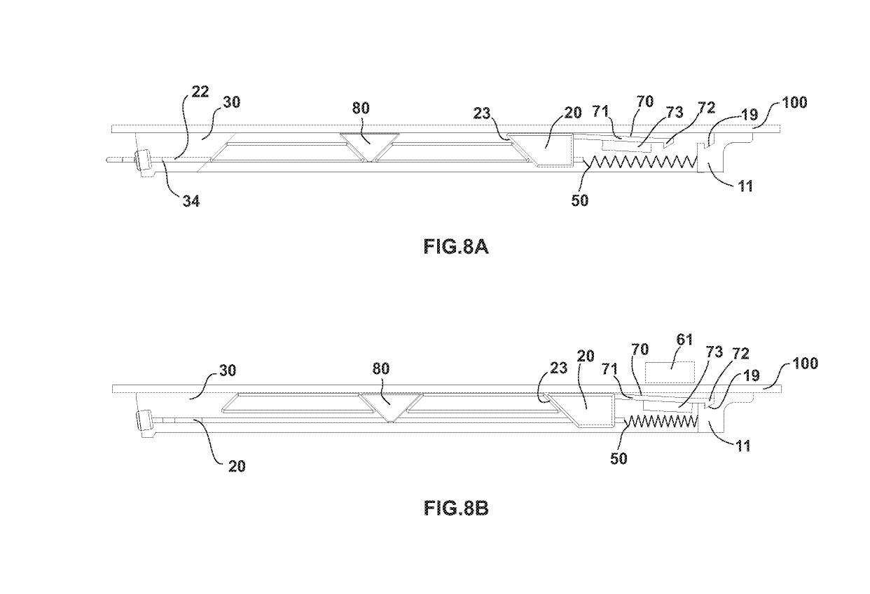

As illustrated in FIGS. 8A and 8B, the connector 10 may also include a latch 70 to maintain the connector 10 in the unlocked position. The latch 70 secures the connector 10 in the locked position. The latch 70 may be initially used prior to the panel 100 being attached to the support member 110, such as prior to initial installation. The latch 70 maintains the distal end 21 of the arm 22 retracted inward to prevent potential damage to the arm 22 that may occur during handling. The latch 70 also positions the arm 22 to prevent accidental connection with an electrical source that could pose a hazard to the user.

The latch 70 includes an elongated arm 71 that extends outward from the movable support 20. The arm 71 extends outward in a direction away from the fixed support 30. The exposed distal end of the arm 71 includes a catch 72 with a tapered width that narrows towards the end. A ferromagnetic member 73 is attached to the arm 71 in proximity to the catch 72. One aspect as included in FIGS. 8A and 8B include the member 73 attached to a bottom side of the arm 71. Member 73 may also be attached to other sections of the arm 71.

The housing 11 includes a corresponding receptacle 19. The receptacle 19 is shaped to contact against the catch 72 and includes an open top side such that the catch 72 can be inserted from the top.

As illustrated in FIG. 8B, the latch 70 in the locked position includes the catch 72 positioned in the receptacle 19. This maintains the movable support 20 in a retracted position such that the distal end 21 of the arm 22 is not exposed beyond the end of the housing 11. To release the latch 70, an actuator 61 as illustrated in FIG. 8B is moved into proximity. The actuator 61 magnetically attracts the ferromagnetic member 73 that is attached to the arm 71. This force causes the arm 71 to move upward and to disengage the catch 72 from the receptacle 19. Once the catch 72 is removed, the force of the biasing members 50 forces the movable support 20 away from the back of the housing 11. This positions the connector 10 in the engaged position with the distal end 21 outward beyond the front of the housing 11 as illustrated in FIG. 8A.

One aspect of use includes the connector 10 being in the unlocked position as illustrated in FIG. 8B. The actuator 61 is brought into proximity to attract the member 73 causing the arm 71 to move towards the actuator 61 and for the catch 72 to disengage from the receptacle 19. The biasing member 50 then applies a force to the member 50 to move the connector 10 to the locked position.

To unlock the connector 10, the actuator 60 is brought into proximity with the engagement member 40. This causes the member 20 to be moved to retract the distal end 21 of the arm 22 inward. Further, actuator 61 is applied to the latch 70. The catch 72 at the distal end of the arm 71 is aligned with the receptacle 19 in the housing 11. In one aspect, the catch 72 disengages with the receptacle 19 with the actuator 61 in proximity to the latch 70 and allows the connector 10 to move to the locked position. Another aspect includes removal of the actuator 61 which provides for the catch 72 to engage with the receptacle 19 and maintain the connector 10 in the unlocked position.

The aspects described above include the engagement member 40 each having a pair of ramped ends. Other aspects may include engagement members 40 with just a single end with a ramped shape. In one aspect, the non-ramped end may form a perpendicular angle with the bottom surface. Likewise, aspects may include just a single one of the movable contact member 20 or the fixed contact member 30 having an acute angled contact face.

The connector 10 provides for mechanical and/or electrical connection with the support member or other adjacent panel. As such, the connector 10 may be used with a wide variety of different types of panels. These include but are not limited to solar panels, wall panels, and sheetrock panels. One aspect includes a solar panel configured to obtain usable solar power through photovoltaics. The panels generally include solar cells that absorb and convert sunlight into electricity, various electrical contacts and cabling, and various electronics such as an inverter to change the electric current from DC to AC. Panels may also include large planar members constructed from wood, metal, plastic, glass, sheetrock, etc. The panels may have a variety of sizes from a relatively small panel that has width and length dimensions in the inches, to relatively large sizes that have dimensions that are in the feet.

Support members are configured to receive and support the panels. The support members may include a frame with a surface configured to contact against and support the panel. The frame may extend around a limited section or the entirety of the panel. The support members are positioned behind the panels such that the panels rest upon or abut against the support members.

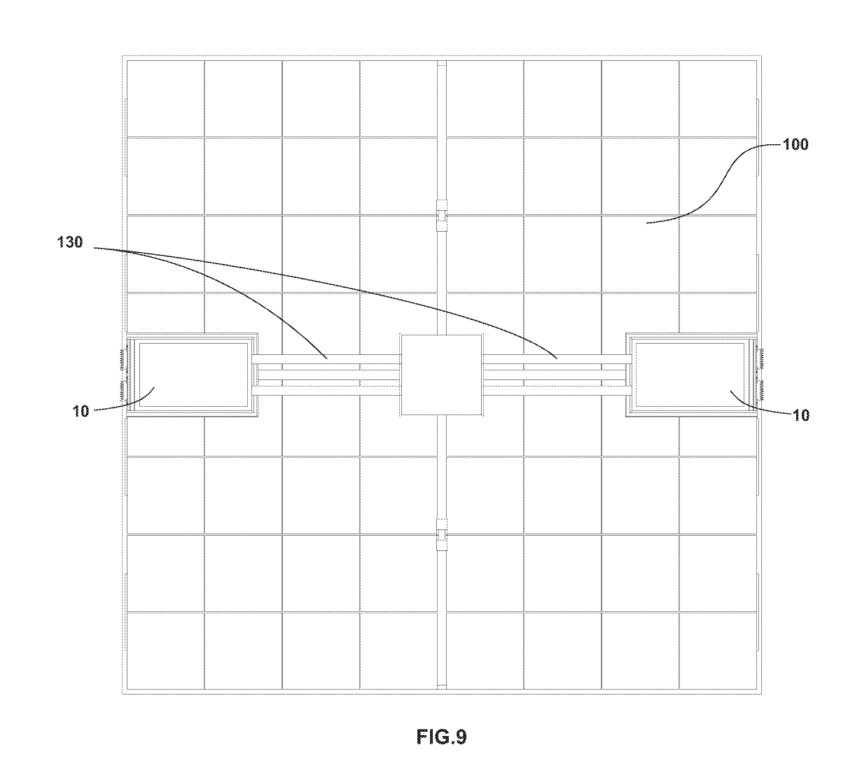

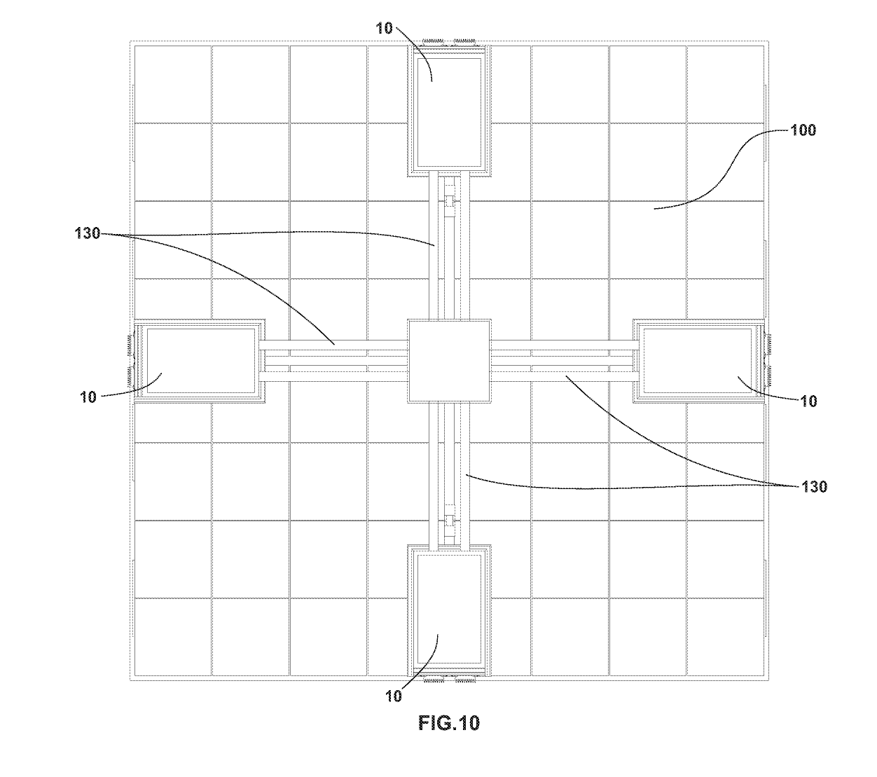

Panels 100 may include different numbers of connectors 10. FIG. 9 illustrates a solar panel 100 that includes a pair of connectors 10 on opposing sides. Solar cells along the panel 100 are connected via electrical connections 130 to the connectors 10. The connectors 10 provide a way to electrically connect the panel 100 to exterior components, such as adjacent panels 100, electrical components, and electrical networks. FIG. 10 illustrates a solar panel 100 with four connectors 10 attached to the underside.

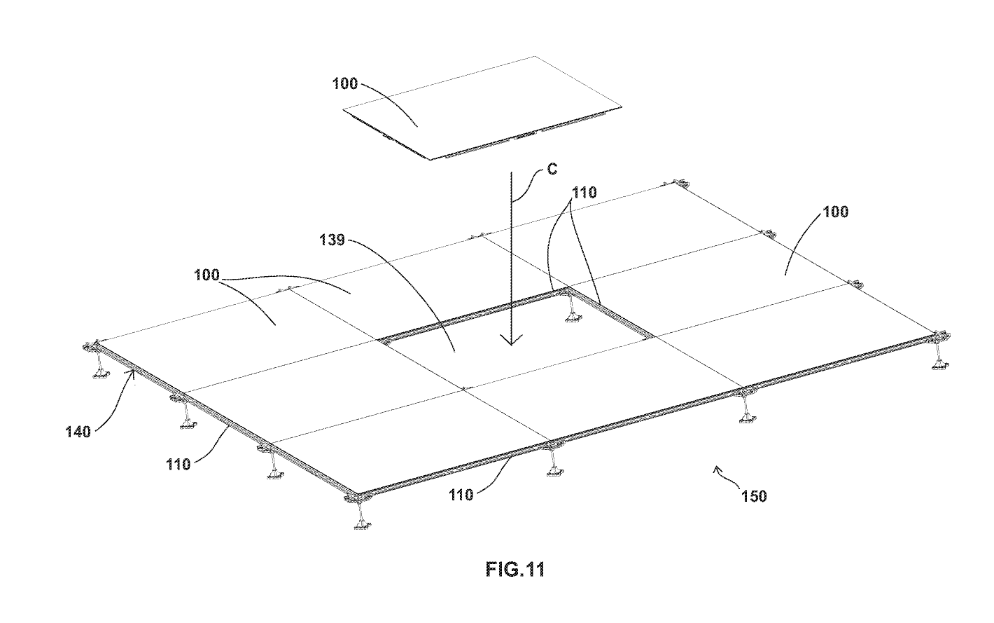

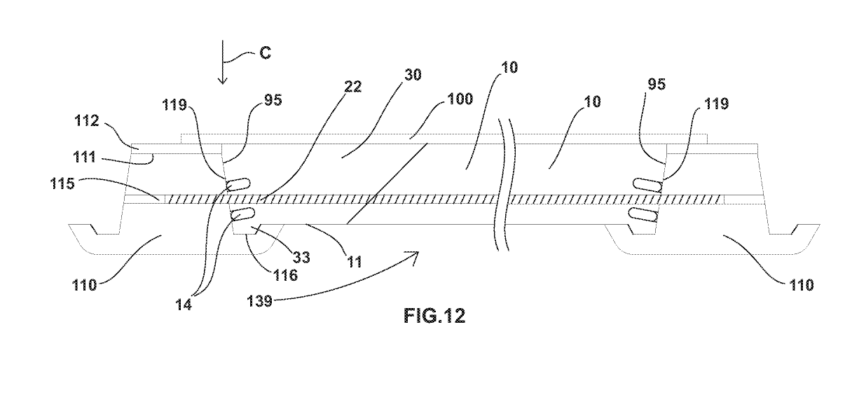

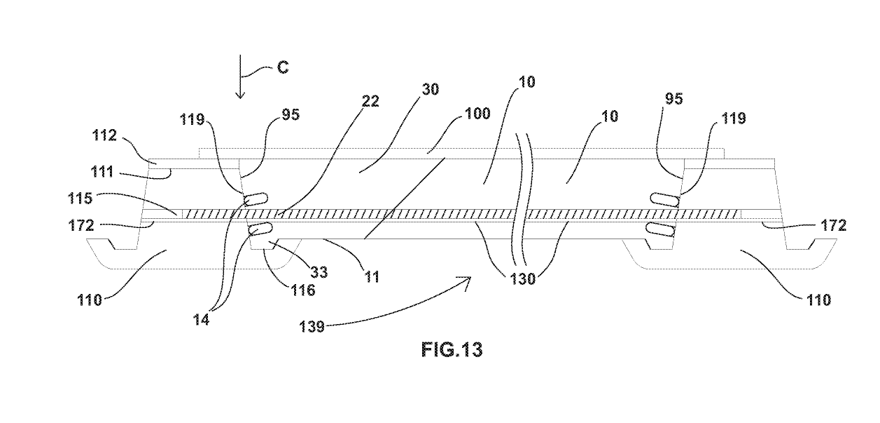

One aspect includes the connectors 10 for use with solar panels 100 that are a component in a larger solar array 150. FIG. 11 includes a solar array 150 that includes nine solar panels 100 aligned in a 3×3 grid. The solar array 150 includes a frame 140 constructed from support members 110. The frame 140 forms receptacle openings 139 each configured to position the solar panels 100 in the desired configuration. FIG. 11 includes one of the solar panels 100 removed from the receptacle 139 to view the underlying frame 140 constructed from the support members 110. The panels 100 are sized to extend across the receptacle 139, which may include completely across the entirety or just a portion of the receptacle 139. The design of FIG. 11 includes the panel 100 sized to extend across an entirety of the receptacle 139 with relatively small gaps positioned at the adjacent panels 100. FIG. 12 illustrates the panel 100 extending completely across the length of the receptacle 139 and extending over portions of each of the opposing support members 110.

The receptacle 139 includes support members 110 along the sides. FIG. 11 includes support members 110 on each of the sides and extending completely around the receptacle 139, although other designs may include support members 110 on fewer sides and/or not extending completely around the receptacle 139. As illustrated in FIG. 12, at least one of the support members 110 includes a surface against which a connector 10 makes contact to secure the panel 100.

The solar panels 100 are planar members that include a series of interconnected solar cells. The solar cells use light energy from the sun to generate electricity through the photovoltaic effect. The solar cells may include various structures, including but not limited to wafer-based crystalline silicon cells or thin-film cells based on cadmium, telluride or silicon. The solar panels 100 may include a variety of different shapes and sizes. In one aspect as illustrated, the panels 100 are rectangular with opposing lateral sides and opposing ends.

The solar cells are electrically connected to the electrical connectors 130 (FIGS. 9, 10). As illustrated, the electrical connectors 130 may extend along the bottom side of the panels 100 and connect to the connectors 10.

The connectors 10 are positioned on the bottom side of the panel 100 as illustrated in FIG. 9. The movable arms 22 of the connectors 10 may extend outward away from a center of the panel 100. The movement of the arms 22 may be towards and away from the center of the panel 100. In one embodiment as illustrated in FIGS. 9 and 10, connectors 10 are positioned on opposing sides of the panel 100.

The array 150 is configured for the panels 100 to be inserted and removed from above the frame 140. As illustrated in FIG. 11 (and FIG. 5), the panels 100 are inserted in a direction C that is perpendicular to a plane formed by the solar panels 100 on the frame 140. Once inserted, the one or more connectors 10 on the panel 100 are extended to engage with the one or more support members 110.

The support members 110 may be configured to receive one or more panels 100. As illustrated in FIG. 12, the panel 100 rests on a portion of the top 111 of the member 110. The top 111 is sized such that the support member 110 can receive an adjacent panel 100 that contacts against and rests on the remainder of the top 111. In one aspect, each of the panels 100 rests on the seal 112 positioned on the top 111 of the support member 110. This positions the panels 100 in a side-by-side arrangement as illustrated in FIG. 11.

The connectors 10 and the support members 110 are configured to facilitate the perpendicular insertion. As illustrated in FIG. 12, the receptacle 139 formed between the support members 110 includes an inwardly-tapering shape. Thus, an upper section of the receptacle 130 is larger and narrows to a smaller lower section. The taper is formed by the outer edges 95 of the connectors 10 being positioned at a non-perpendicular angle relative to the panel 100.

The connectors 10 give the solar panel 100 a complementary tapering shape. This shape is formed by the edges 119 of the support member 110 positioned at a complementary angle. As illustrated in FIG. 12, the connectors 10 form an inwardly-tapering outer edge 95 that is received in the receptacle 139 formed by the support members 110. In one embodiment, edge 95 extends at an acute angle that is measured between the edge 95 and the second side of the panel 100.

The complementary tapering shapes facilitate insertion in the vertical direction C. This further provides for the panel 100 to seat against the support members 110 and provide an effective connection with the seals 112 on the top 111 of the members 110. Further, seals 14 positioned at the end of the connector 10 are compressed against the support member 110. With the tapering shapes, the receptacle 139 is larger at the top surface and smaller at the bottom. This is illustrated in FIG. 12.

As further illustrated in FIG. 12, the connectors 10 include the lip 33 that seats within the notch 116 of the support member 110. This prevents the panel 100 from moving laterally away from the support member 110 when engaged. When the panel 100 includes multiple connectors 10 that engage support members 110 on multiple sides, the interaction acts to secure the position and prevent movement of the panel 100 relative to the frame 140.

As illustrated in FIGS. 11 and 12, the panel 100 is secured in the frame 140 with a planar first side of the panel 100 being exposed and the opposing second planar side of the panel 100 facing downward towards the frame 140 that is constructed from support members 110. The connectors 10 on the second side of the panel 100 are positioned to engage with the support members 110.

Each of the connectors 10 is configured with the biasing members 50 biasing the movable support 20 away from a center of the panel 100 to an engaged position against a support member 110. This secures the panel 100 to the frame 140 during use.

To remove the panel 100 from the frame 140, the connectors 10 are moved to a disengaged position. This occurs with the one or more engagement members 40 in each of the connectors 10 being magnetically attracted towards the first side of the panel 100. This may occur when a user positions the actuator 60 in proximity to the engagement member 40. The magnetic attraction overcomes the biasing force applied by the biasing member 50. Thus, the support 20 is retracted inward towards the center of the panel 100. This may include moving the distal end 21 of the support 20 inward from the perimeter edge of the panel 100. The support 20 may be locked in the retracted position by engaging and arm of the connector 10 in a receptacle 19.

Each of the connectors 10 may be returned to the engaged position by moving the engagement member 40 away from the first side of the panel 100. This may be caused by moving the actuator 60 away from the connector 10. This movement causes the support to move to the engaged position. This may be caused by the biasing force that is applied to the support 20 by the biasing member 50. In the engaged position, the distal end of the support 20 may extend outward beyond the perimeter edge of the panel 100. When the support 20 is locked, a magnetic member of the arm may be attracted towards the first side of the panel 100 and unlocked.

The movement of the engagement members 40 towards and away from the panel 100 may occur in a plane that is perpendicular to the first side of the panel 100. The movement of the support 20 may be in a plane that is parallel to the first side of the panel 100.

The connectors 10 may apply a force to the panel 100 through the configuration of the contact between the support 20 and the support member 110. This force pulls the panel 100 towards the top surface of the supports 110. The top surface of one or more of the supports 110 may include a seal 112. The force may cause the seal 112 to compress thus facilitate the engagement and preventing and/or reducing ingress of water and/or debris.

The connector 10 may include a pair of biasing members 50 as illustrated in the drawings, or may include a single biasing member or three or more biasing members 50 as necessary to apply the needed biasing force.

The panel 100 may include a body that has planar first and second sides. This may include that one or both of the sides is flat. The body may include a variety of shapes, including a polygonal shape as illustrated in FIG. 11, circular shape, and a variety of miscellaneous shapes. The body includes an outer edge that extends between the first and second sides. In one embodiment, the panel 100 has a polygonal shape with multiple straight sides, and connectors 10 are positioned along at least two of the sides.

The panel 100 may be constructed from cardboard.

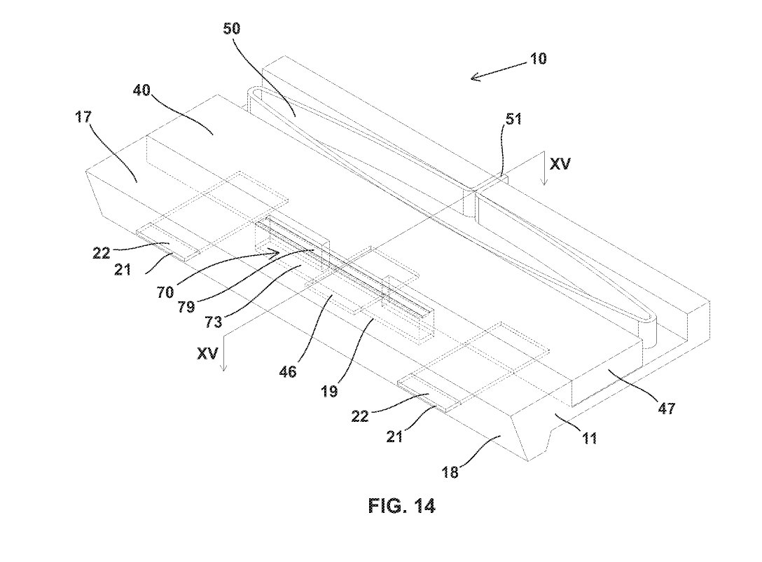

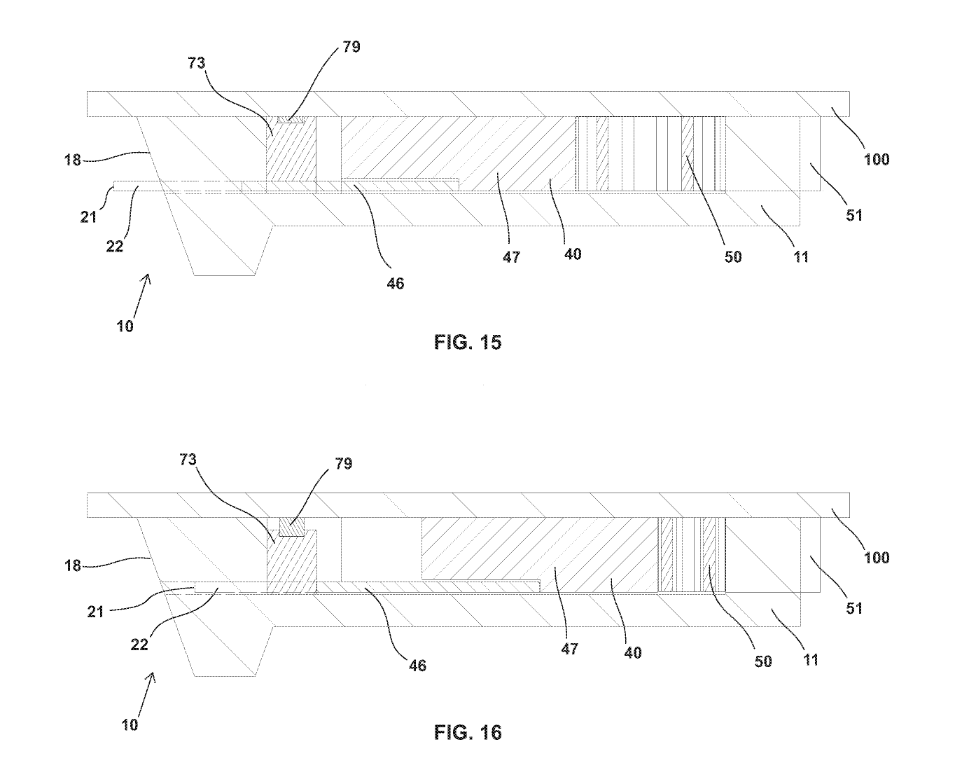

The connector 10 may have a variety of different configurations to engage and disengage from the support members 110. FIG. 14 includes the connector 10 removed from the panel 100. In use, the connector 10 is attached to the second side of the panel and extends over the components in the connector (as illustrated in FIGS. 15, and 16).

The engagement member 40 which is constructed from a ferromagnetic material is positioned within the interior of the housing 11. The engagement member 40 includes a main section 47 and an outwardly-extending finger 46. The finger 46 includes a smaller thickness than the main section 47 forming a ledge. The engagement member 40 is sized and configured to move within the interior space of the housing 11. The movement includes a first position with the finger 46 extended outward laterally beyond the latch 70 (as illustrated in FIGS. 14 and 15) and a second position with the latch retracted laterally back. In one embodiment, this movement between the positions is parallel to a top surface of the panel 100.

The connector 10 also includes a biasing member 50 such as a spring that is positioned behind the engagement member 40. The biasing member biases the engagement member 40 towards a front edge 18 of the housing 11.

The electrically conductive arms 22 are operatively connected to the engagement member 40. The arms 22 provide for electrical and mechanical connections with the support member 110 and/or adjacent panel 100. The arms 22 are connected to the engagement member 40, which in turn is in contact with the biasing member 50. The biasing member 50 may include a tail 51 that extends outward from a rear of the housing 11. The tail 51 is connected to one or more electrical connectors on the panel 100. Thus, the arms 22 may be electrically connected to the panel 100. In other designs, the arms 22 include an elongated shape with a proximal end that is operatively connected to the panel 100 in a manner similar to FIGS. 6A-7B described above.

The arms 22 also include a distal end 21 that extends outward in the extended position. The arms 22 are attached to the movable engagement member 40. Thus movement of the engagement member 40 in the interior space of the housing 11 results in movement of the arms 22. The arms 22 may be electrically isolated from the other components of the connector 10, particularly the engagement member 40. This may include an insulating material positioned around the arms 22 to provide electrical isolation.

A latch 70 is positioned to secure the connector 10 in the retracted position. The latch 70 includes a biasing member 79 and a ferromagnetic member 73. The biasing member 79 and ferromagnetic member 73 may be constructed as a single unitary piece, or may be separate elements that are positioned together. The ferromagnetic member 73 includes an elongated shape and is positioned between the main section 47 to the engagement member 40 and the front edge 18 of the housing 11.

The housing 11 includes a receptacle 19 that locates the ferromagnetic member 73. In one design, the housing 11 includes a thickened wall 17 that forms the front edge 18. The wall 17 includes a receptacle 19 sized to contain the ferromagnetic member 73 and allow for up-and-down movement of the member 73. The wall 17 also includes slots such that the arms 22 can extend through in the extended position. In one design, the top of the receptacle 19 is open.

Another design includes the receptacle 19 positioned within the hollow interior of the housing 11. The receptacle 19 extends upward from the floor of the housing 11. The height of the receptacle 19 may vary between extending a limited distance upward from the floor enough to prevent movement of the ferromagnetic member 73 within the housing 11, to extending the complete distance between the floor and a top edge of the housing 11. The length and width dimensions may be slightly larger than the member 73 to receive and position the member 73, but prevent or limit movement.

FIG. 14 illustrates the connector 10 in an extended position with the latch 70 in a first orientation. In this design, the housing wall 17 includes an enlarged thickness. The receptacle 19 is positioned within the wall 17 and the arms 22 extend through the wall 17 in the extended position.

FIG. 15 illustrates a connector 10 in an extended position. The ferromagnetic member 73 is attracted upward towards the panel 100 by a magnetic actuator 60 (not illustrated). The attraction force acting on the ferromagnetic member 73 overcomes the opposing force applied by the biasing member 79. This results in the ferromagnetic member 73 moving upward toward the panel 100. This causes the ferromagnetic member 40 to move forwards with the finger 46 of the engagement member 40 moving under the ferromagnetic member 73 because of the force of the biasing member 50 acting on the engagement member 40. This also results in the arms 22 moving forward and the distal ends 21 extending outward from the front edge 18 of the housing 11 to engage with the support member 110 (not illustrated).

FIG. 16 illustrates a connector 10 in a retracted position. The ferromagnetic member 73 is located in a lowered position in front of the engagement member 40 and the finger 46. This positioning causes the finger 46 to contact against the latch 70 and block the engagement member 40 from moving towards the front edge 18 of the housing 11. This positioning keeps the distal ends 21 of the arms 22 retracted within the housing 11.

The magnetic actuator 60 is used to move the connector 10 between the retracted and extended positions. The magnetic actuator 60 is configured to apply a separate magnetic force to each of the engagement member 40 and the latch 70. The magnetic actuator 60 may be a single member configured to emit separate magnetic forces, or may be two separate members each configured to apply a magnetic force.

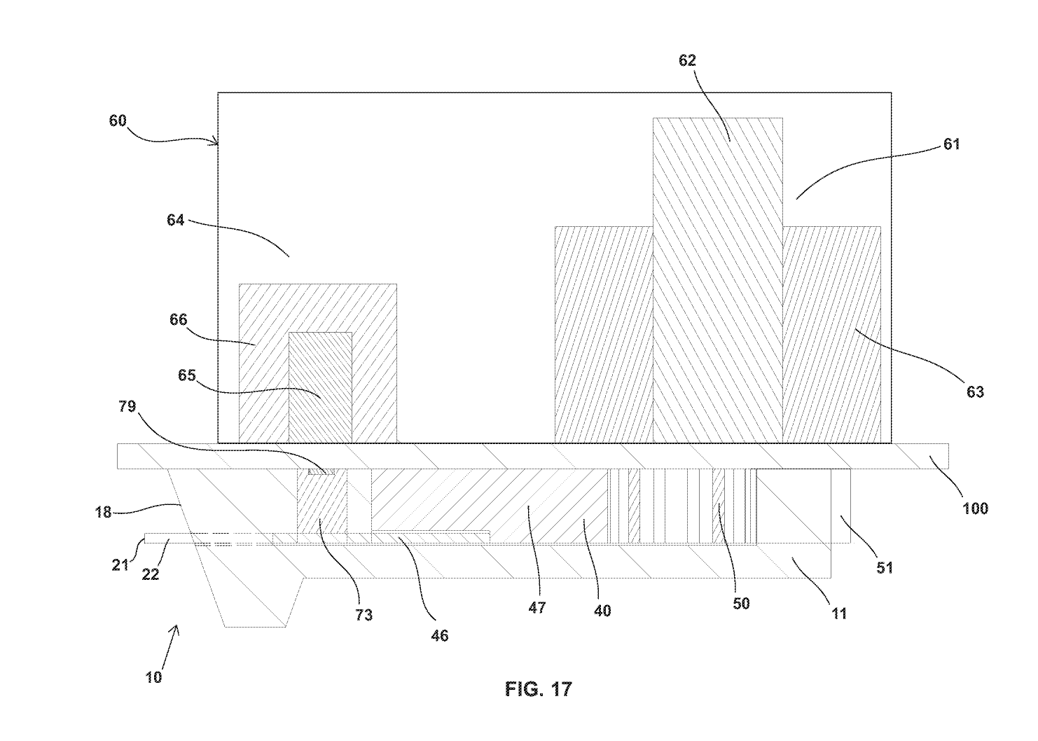

FIG. 17 illustrates a magnetic actuator 60 positioned on the top surface of the panel 100. The actuator 60 includes a first element 61 that applies a magnetic force to the engagement member 40, and a second element 64 that applies a magnetic force to the latch 70. The first element 61 includes an electromagnetic core 62 and coil 63. The second element 64 includes an electromagnetic core 65 and coil 66. The actuator 60 includes one or more switches to activate and deactivate the elements 61, 64 to in various combinations to move the connector 10 between the extended and retracted positions.

FIGS. 15-17 include the back arm 22 in dashed lines where it is retracted into the housing 11. This assists in demonstrating the movement as the engagement member 40 moves within the housing 11.

In use, when the connector 10 is in the extended position, the first element 61 is activated to attract the engagement member 40 away from the front edge 18 of the housing 11. The biasing member 79 of the latch 70 applies a downward force on the member 73 thus moving it directly in front of the distal end of the finger 46 of the engagement member 40 as illustrated in FIG. 16. Once at this position, the first element 61 is deactivated causing the force of the biasing member 50 to apply a forward force to the engagement member 40. The position of the member 73 in front of the engagement member 40 prevents the engagement member 40 from moving forward. This results in the arms 22 remaining retracted inward.

To move the connector 10 from the retracted to the extended position, the second element 64 is activated. This attracts the member 73 upwards towards the element 64. This allows the biasing force that is being applied to the engagement member 40 by the biasing member 50 to then slide the engagement member 40 forward towards the front edge 18. This results in the member 73 being positioned above the finger 46 as illustrated in FIG. 17. This movement of the engagement member 40 towards the front edge 18 results in the attached arms 22 to also move in this direction and for the distal ends 21 to extend outward beyond the housing 11.

In moving to the extended position, prior to activating the second element 64, the first element 61 may be activated to remove the biasing force of the spring 50 from acting on the engagement member 40. Once removed, the second element 64 is activated and the first element 61 is deactivated allowing the biasing force to be applied to the engagement member 40 and move the engagement member 40 forward towards the front edge 18.

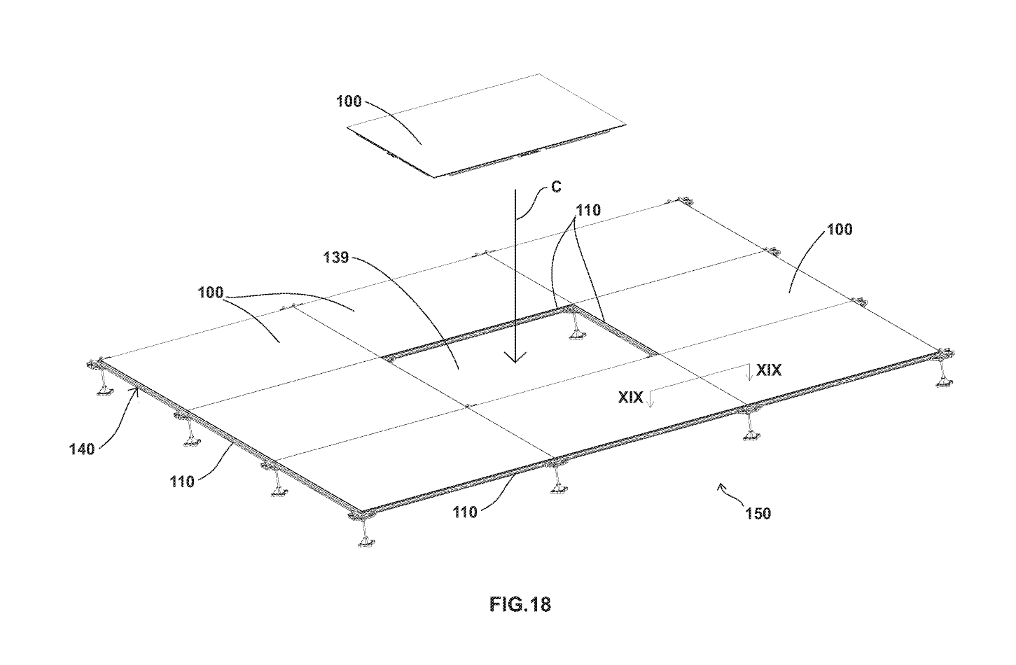

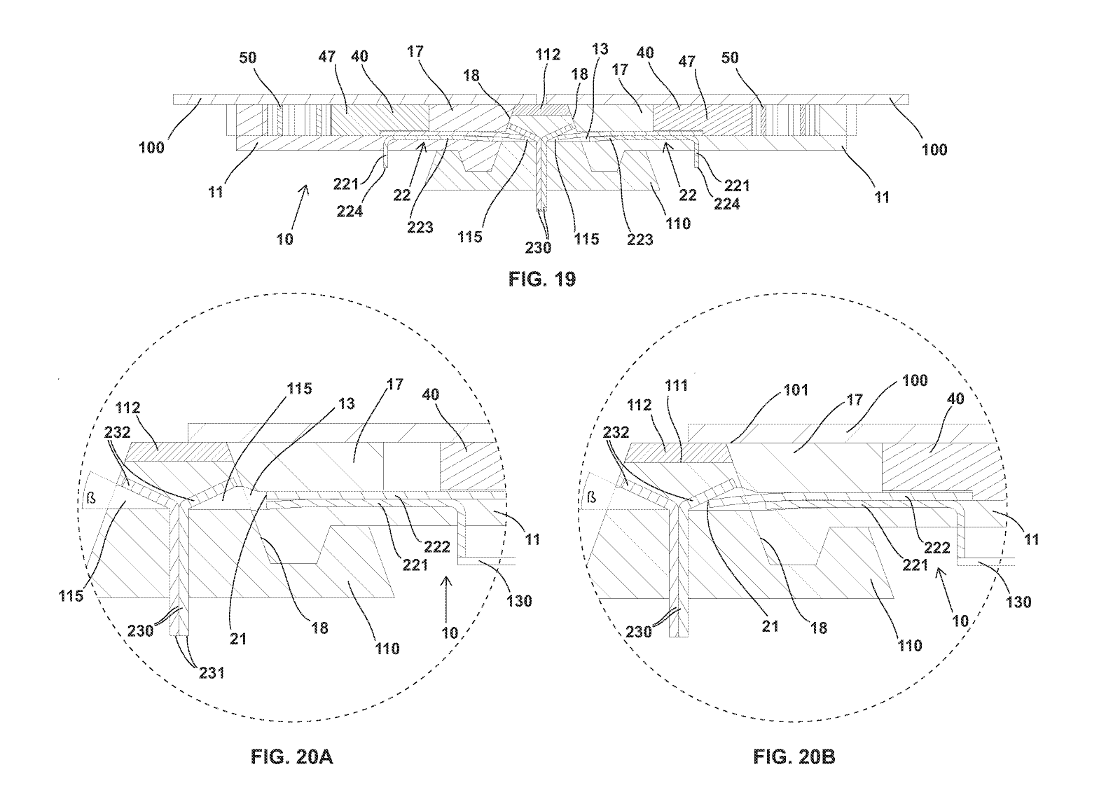

The arms 22 may include other configurations to engage with the support members 110. FIG. 19 illustrates a schematic side view of a pair of panels 100 connected to an intermediate support member 110. This configuration may occur in a panel array 150 as illustrated in FIG. 18. Each attachment arm 22 is constructed from a first section 221 and a second section 222. The first section 221 is fixedly connected to the housing 11 and does not move with the engagement member 40. The first section 221 includes a first leg 223 that is positioned along a slot 13 in the housing wall 17. The first leg 223 may also extend underneath the main section 47. The first section 221 also includes a second leg 224 that is positioned at an end of the first leg 223. In one design, each of the first and second legs 223, 224 are substantially straight and the second leg 224 extends outward from an end of the first leg 223 at a right angle. The second leg 224 extends outward from the floor of the housing 11. The second leg 224 may be connected to electrical connector 130 (not illustrated) to electrically connect the panel 100 to the support member 110 and/or adjacent panel 100.

The second section 222 includes a straight shape with a first end that is mounted to the main section 47 of the engagement member 40 and an opposing distal end 21. The second section 222 is in contact with and electrically connected to the first section 221. The second section 222 is movable with the main section 47 of the engagement member 40. Thus, the second section 222 slides along the first section 221 with the distal end 21 extended outward beyond the front edge 18 of the housing 11 in an extended position and retracted inward into the slot 13 in a retracted position.

When the panels 100 are seated onto the support member 110, the slots 13 in the housings 11 align with slots 115 in the support member 110. Electrical connectors 230 in the support member 110 are positioned at the slots 115 and engage with the second section 222 to provide an electrical connection between the panels 100 and the support member 110. The connectors 230 include a first section 231 and a second section 232. As illustrated in FIGS. 20A and 20B, the sections 231, 232 are aligned at an obtuse angle. The second section 232 is aligned at an angle ß with a bottom of the slot 115.

FIG. 20A illustrates one of the panels 100 positioned at a support member 110. The slot 13 of the housing 11 is aligned with the slot 115 of the support member 110. The connector 10 is in a retracted position with the distal end 21 of the second section 222 recessed in the slot 13 of the housing 11.

FIG. 20B illustrates the connector 10 electrically connected to the support member 110. In this position, the second section 222 has moved outward with the main section 47 of the engagement member 40. This causes the distal end 21 to contact against the electrical connector 230 in the support member 110. Specifically, the distal end 21 contacts against the second section 232 of the electrical connector 230. Thus, electricity from the panel 100 moves along the electrical connector 130, to the first section 221 that contacts the electrical connector 130, to the second section 222 that contacts the first section 221, and to the electrical connector 230 in the support member 110. When the arm 22 moves to the extended position, the first section 221 remains stationary to maintain the electrical connection with the panel 100 (such as through the electrical connector 130 as illustrated in FIGS. 20A and 20B).

The connector 10 and the support member 110 are configured to ensure contact between the arm 22 and the electrical connector 130. As illustrated in FIG. 20B, the second section 222 of the arm 22 is constructed of a flexible material that bends when in contact with the electrical connector 230. This bending is facilitated by the positioning of the second section 232 at the angle ß. The second section 232 is more rigid than the second section 222 of the arm 22. This results in the distal end 21 contacting against the second section 232 and sliding along the second section 232 towards the floor of the slot 115. This motion bends the second section 222 of the arm as illustrated in FIG. 20B. This ensures adequate contact between the distal end 21 and the electrical connector 230 to provide for a solid electrical connection.

To further facilitate the bending, the distal end of the first section 221 may be bent away from the distal end 21 of the second section 222 as illustrated in FIG. 20A. This provides additional space for the second section 222 to bend upon contact against the electrical connector 230.

The bending of the second section 222 also applied a downward force on the panel 100 against the support member 110. This downward force provides for the panel 100 to seat properly against the support member 110. This downward force may also provide for deforming the seal 112 positioned between the panel 100 and the support member 110 to prevent the ingress of water or other debris when the panel 100 is mounted to the support member 110.

Another design includes the second section 222 being constructed of a material that does not bend during contact with the connector 230. The second section 222 may extend straight outward from the housing 11 with the distal end 21 of the second section 222 abutting against and contacting the connector 230.

In one design, the electrical connectors 230 in the support member 110 provide for transferring power from one panel 100 to the next panel 100. The electrical connectors 230 are electrically connected together to provide for this transfer, such as being in contact against one another. In another design, the electrical connectors 230 provide for transferring the electrical power from one or more panels 100 out of the support member 110 to a remote entity. In one design, the first ends 231 of the electrical connectors 230 are electrically connected to connectors to provide a conductive path off the array of support members 110.

In one design, electrical power on each panel 100 flows through the biasing member 50. The biasing members 50 are electrically connected to the arms 22 through engagement member 40 or other intermediate connector. Thus, electrical continuity is provided between the biasing members 50.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive.

What is claimed is:

1. An array comprising:
supports that include a top surface and side walls that extend outward away from the top surface, and an opening formed between the supports, at least one of the side walls at the opening comprising a contact member;
a panel sized to be positioned over the top surface of the supports and extend across the opening, the panel comprising a first side that is exposed when the panel is positioned at the opening and an opposing second side that faces towards the top surface when the panel is positioned at the opening, the panel also comprising an outer edge that extends between the first and second sides;
a connector attached to the second side of the panel, the connector comprising:
an engagement member configured to move relative to the panel between an engaged position that extends outward away from a center of the panel and a retracted position that is retracted inward towards the center of the panel; and
a ferromagnetic member configured to be acted upon by a magnetic force and move relative to the panel between a first position and a second position;
the ferromagnetic member being selectively positioned between the first position that locates the engagement member in the engaged position in contact with the contact member on the side wall, and the second position that locates the engagement member in the retracted position inward towards the center of the panel and out of contact with the contact member on the side wall.

2. The array of claim 1, wherein the supports extend completely around the opening.

3. The array of claim 1, wherein the connector further comprises a spring that biases the engagement member towards the engaged position.

4. The array of claim 1, wherein the contact member is positioned at an incline with a distal end of the contact member contacting against the incline in the engaged position to apply a force to the panel that pulls the panel towards the top surface of the supports.

5. The array of claim 1, further comprising a seal positioned between the top surface of the supports and the second side of the panel, the seal constructed from a material that is more compressible than the supports, the seal being compressed when the connector is in the engaged position and in contact with the contact member in the side wall.

6. The array of claim 1, wherein at least one of the side walls at the opening comprises an inwardly-angled face with a width of the opening being larger at the top surface of the supports and smaller at a bottom of the supports, and with the connector having an outer face with a complementary angle such that the outer face of the connector contacts against the at least one of the side walls when the panel is positioned at the opening.

7. The array of claim 6, wherein the side walls of the supports further comprise a notch and the connector further comprises a lip that extends outward away from the second side of the panel, wherein the lip is sized to seat within the notch when the panel is positioned at the opening.

8. The array of claim 1, wherein at least one of the side walls comprises a gap and the engagement member extends into the gap in the engaged position.

9. The array of claim 8, further comprising a side seal mounted on the connector and configured to contact against the side wall when the engagement member is in the engaged position to prevent water from contacting against the engagement member.

10. An array comprising:
a panel comprising first and second planar sides;
first and second connectors attached to the second side of the panel at opposing edges of the panel, each of the connectors comprising:
a contact face that extends at an acute angle from the second side of the panel;
a lip; and
an engagement member movable between an extended position that extends outward from the contact face and a retracted position that is retracted inward from the contact face;
a frame with a first support and a second support, the frame comprising an opening formed between the first support on a first side of the opening and the second support on a second side of the opening, each of the first and second supports comprising:
a top surface;
a side wall that extends outward away from the top surface and includes an inwardly-angled face that complements the acute angle of the contact face;
a contact member positioned in the side wall;
a receptacle positioned below the side wall;
the panel positioned on the frame and extending over the top surface of each of the first and second supports and with each of the connectors positioned with the outer face of each of the connectors in contact against the face of one of the side walls and with the engagement member of each of the connectors in the extended position being in contact with the contact member of one of the supports, and with the lip of each of the connectors positioned in the receptacle of one of the supports to prevent the connector from moving away from the side wall towards a center of the opening.

11. The array of claim 10, wherein the opening includes a width measured between the first and second supports, the width of the opening being greater at the top surface of the supports and smaller at a bottom of the supports.

12. The array of claim 10, wherein each of the connectors includes a body with the contact face positioned on a lateral side of the body, the lip positioned on a bottom side of the body, and a top side of the body being attached to the second side of the panel.

13. The array of claim 10, wherein each of the connectors further comprises a ferromagnetic member movable in a plane that is perpendicular to the first side of the panel, the ferromagnetic member being selectively positioned between a first position that is a first distance away from the first side of the panel that positions the engagement member in the extended position against the contact member, and a second position a different second distance away from the first side of the panel that positions the engagement member in the retracted position inward towards the center of the panel and out of contact with the contact member.

14. The array of claim 10, wherein the panel is a solar panel and the first side of the panel is exposed when the panel is positioned on the frame.

15. The panel of claim 10, wherein the engagement member of each of the connectors extends outward beyond the edges of the panel in the extended position.

16. The array of claim 10, wherein the connectors are configured to apply a force to the panel that pulls the panel towards the top surface of the supports when the connectors are in the engaged position and in contact with the contact members in the side walls.

17. The array of claim 16, further comprising a seal positioned between the top surface of the supports and the second side of the panel, the seal constructed from a material that is more compressible than the supports, the seal being compressed when the connectors are in the engaged position and in contact with the contact members in the side walls.

18. The array of claim 10, wherein each of the connectors further comprises a ferromagnetic member movable in the housing between a first position that positions the engagement member in the extended position against the contact member, and a second position away from the first position that positions the engagement member in the retracted position inward towards the center of the panel and out of contact with the contact member.

19. An array comprising:
a panel comprising first and second planar sides, the panel comprising a polygonal shape with at least first and second outer edge sections on opposing sides of the panel;
first and second connectors attached to the second side of the panel, the first connector attached at the first outer edge section and the second connector attached at the second outer edge section, each of the connectors comprising:
a body that extends outward away from the second side of the panel with a contact face oriented at an acute angle from the second side of the panel, the body also comprising a bottom side with a lip; and
an engagement member movable between an extended position that extends outward from the contact face and a retracted position that is retracted inward from the contact face;
a frame that includes an opening sized to receive the panel, the frame comprising a first support on a first side of the opening and a second support on a second side of the opening, the opening having a width measured between the first and second sides that is greater at a top and smaller at a bottom, each of the first and second supports further comprising notches;
the panel configured to be positioned on the frame to extend over the first and second supports and with the contact face of the first connector abutting against the first support and the contact face of the second connector abutting against the second support;
the lip of first connector configured to be inserted into the notch of the first support and the lip of the second connector is configured to be inserted into the notch of the second support to prevent the panel from moving away from the first and second supports towards a center of the opening.
